(19) United States
(12) Patent Application Publication
(10) Pub. No.: US 2003/0218031 A1
(43) Pub. Date: Nov. 27, 2003

(54) Water bag

(76) Inventor: Shih-Sheng Yang, Taipei (TW)

Correspondence Address: Shih-Sheng YANG, PO Box 82-144, TAIPEI, TW

(21) Appl. No.: 10/153,777

(22) Filed: May 24, 2002

(51) Int. Cl. B67D 3/00

(52) U.S. Cl. 222/527

(57) ABSTRACT

A water bag having a collapsible waterproof bag body provided with a mouth at one end and a suction valve controlled water outlet at the other end, strips of hook material and strips of loop material provided at the bag body at different elevations and adapted for securing the mouth in a closed rolled up status, and a plastic springy strip embedded in a two-layer structure of one of two opposite bag body sidewall of the mouth for squeezing by fingers to stretch open the mouth after the strips of hook material unfastened from the strips of loop material and the mouth extended out.

### BACKGROUND OF THE INVENTION

1. Field of the Invention

The present invention relates to a water bag and, more particularly, to such a water bag that enables the user to clean its inside conveniently.

2. Description of the Related Art

FIG. 1 illustrates a water bag according to the prior art. This structure of water bag comprises a collapsible bag body 1, a filling hole 2 disposed near the bottom side of the bag body 1, a cap 3 hinged to the bag body 1 and adapted for closing the filling hole 2, a suction tube 4 extended from the bag body 1 near the top side for enabling the user to suck in water from the bag body 1, a suction valve 5 adapted for closing/opening the suction tube 4, and a drain valve 6 at the bottom side of the bag body 1. This structure of water bag is collapsible and suitable for use outdoors. However, it is inconvenient to clean the inside wall of the bag body 1. When cleaning the inside wall of the bag body 1, the user must insert a stick brush through the filling hole 2 to rub the inside wall of the bag body 1. This cleaning method cannot thoroughly clean all corners inside the bag body 1.

Therefore, it is an object of the present invention to provide an improved water bag which can obviate the above-mentioned drawbacks.

### SUMMARY OF THE INVENTION

The present invention relates to a water bag and, more particularly, to such a water bag that enables the user to clean its inside conveniently.

The present invention has been accomplished to provide a water bag, which eliminates the aforesaid problem. It is therefore the main object of the present invention to provide a water bag, which enables the user to conveniently thoroughly clean the inside of the bag body. To achieve this and other objects of the present invention, the bag body of the water bag is provided with a mouth through which water is filled in the bag body. When the mouth opened, the user can easily thoroughly clean the inside of the bag body. Further, fastening means is provided for closing the mouth after the bag body filled up with water.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic drawing showing a water bag according to the prior art.

FIG. 2 is a schematic drawing showing the outer appearance of a water bag according to the present invention.

FIG. 3 is a front view of a part of the present invention showing the mouth opened.

FIG. 4 is a rear view of a part of the present invention showing the mouth closed.

FIG. 5 is a schematic drawing showing the action of sealing the mouth according to the present invention (I).

FIG. 6 is a schematic drawing showing the action of sealing the mouth according to the present invention (II).

FIG. 7 is a schematic drawing showing the action of sealing the mouth according to the present invention (III).

FIG. 8 is a schematic drawing showing the action of sealing the mouth according to the present invention (IV).

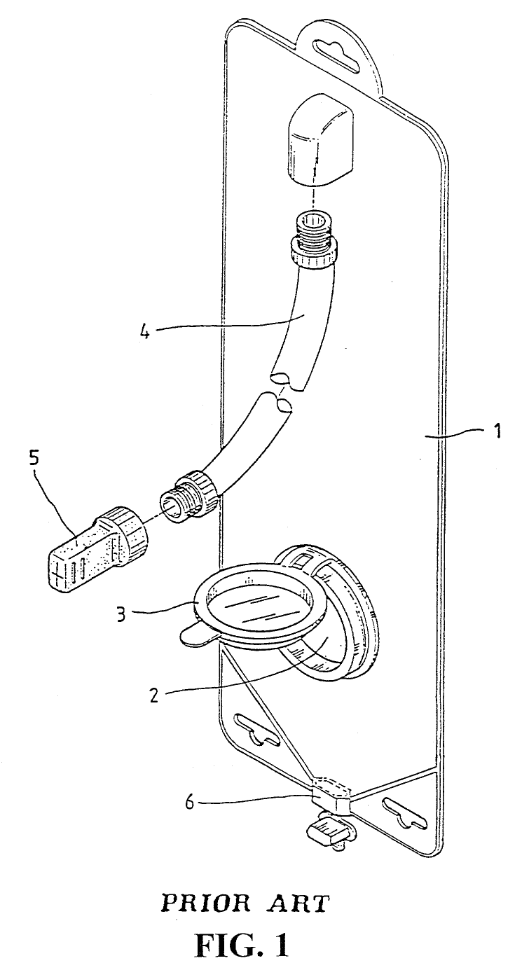

### DETAILED DESCRIPTION OF THE PREFERRED EMBODIMENT

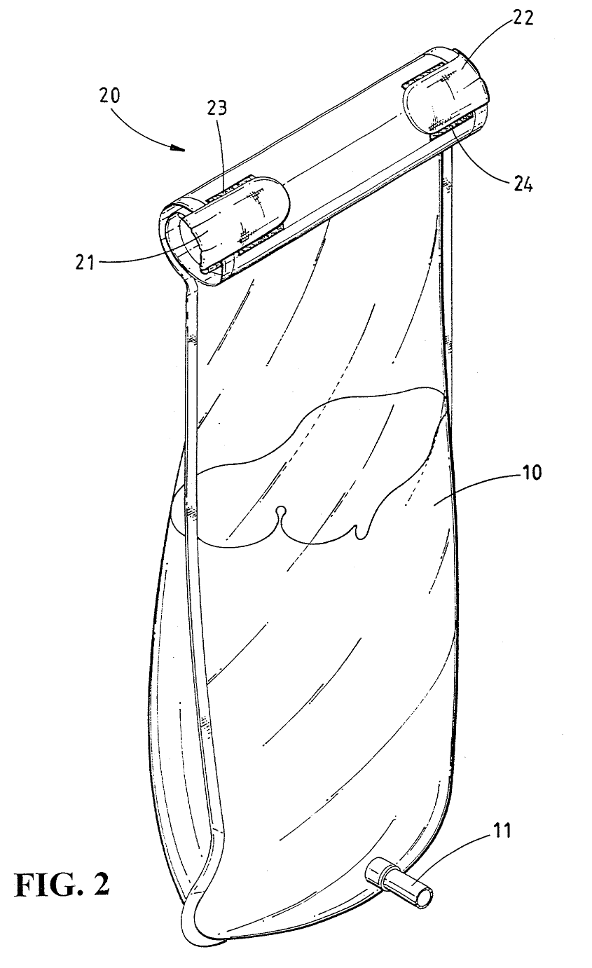

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims. Referring to FIG. 2, a water bag is shown comprising a collapsible waterproof bag body 10 adapted for holding drinking water, a water outlet 11 in one end of the bag body 10 for output of drinking water. The water outlet 11 is provided with a capped suction nozzle convenient for enabling the user to suck in drinking water from the water outlet 11. The water bag is convenient for carrying by the user or on the bicycle during an outdoor sports game or activity.

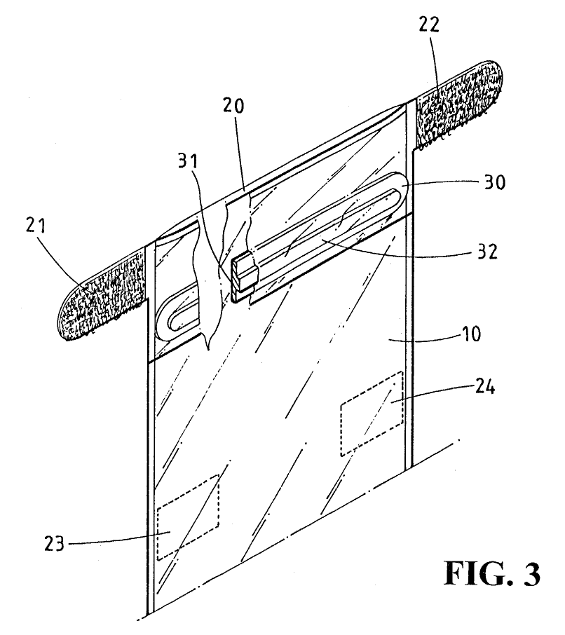

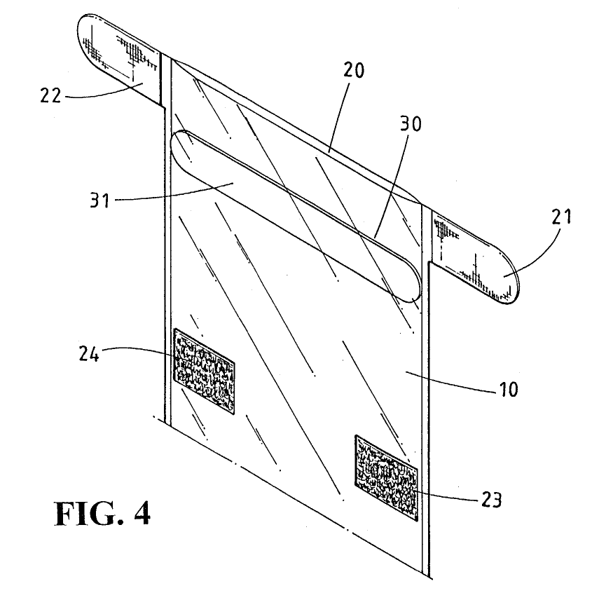

Referring to FIGS. 3 and 4 and FIG. 2 again, the bag body 10 has a mouth 20 in one end thereof remote from the water outlet 11. The two opposite bag body sidewalls of the mouth 20 adhered to each other when wet due to the effect of the material property of the bag body 10 (the two opposite bag body sidewalls of the mouth 20 are respectively made of polyurethane). The water bag further comprises two first fastening elements, for example, two strips of hook material 21; 22 stitched to the periphery of the mouth 20 at two sides, and two second fastening elements, for example, two strips of loop material 23; 24 stitched to a part of the bag body 10 at two sides on the outside and adapted for fastening the strips of hook material 21; 22 respectively. A plastic springy strip 30 is transversely embedded in the two-layer structure of one bag body sidewall of the mouth 20 and fixedly sealed thereto by a high frequency heat sealing apparatus. The plastic springy strip 30 has a planar wall portion 31 disposed at an inner side facing the inside of the water bag, and an elongated rib 32 extended along the length thereof and disposed at an outer side facing the outside of the water bag.

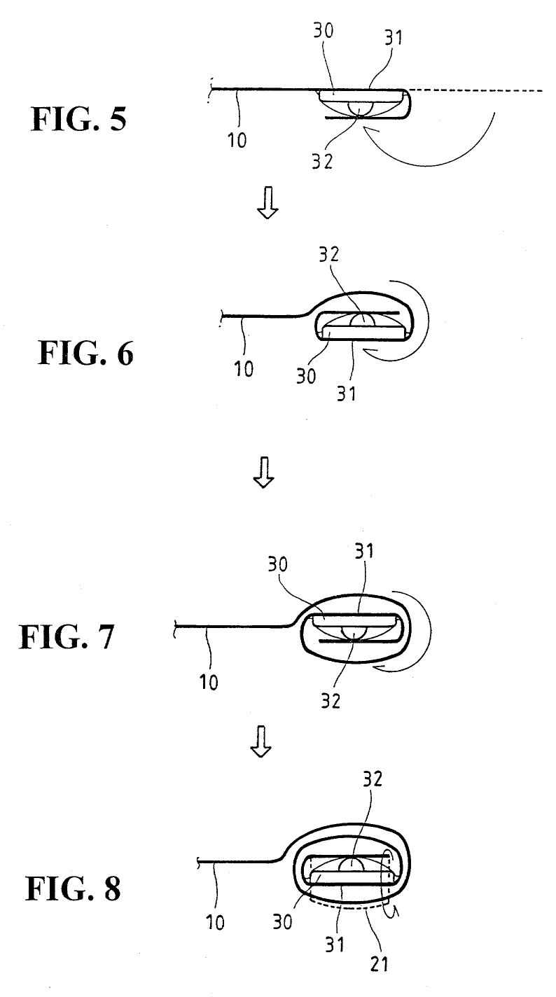

Referring to FIGS. from 5 through 8 and FIG. 2 again, after the bag body 10 has been filled up with drinking water, squeeze the two opposite bag body sidewalls of the mouth 20 with the fingers to force the two opposite bag body sidewalls of the mouth 20 to adhere to each other, and then roll up the closed mouth 20 with the plastic springy strip 30 set as the axis (see FIGS. 5 and 6), and then repeatedly roll up the closed mouth 20 tightly (see FIGS. 7 and 8), and then fasten the strips of hook material 21; 22 to the strips of loop materials 23;24 respectively to secure the closed mouth 20 in the tightly rolled up status (see FIG. 8). Therefore, the mouth 20 is firmly secured in the closed position. When opening the mouth 20, unfasten the strips of hook material 21; 22 from the strips of loop materials 23; 24, and then extended out the mouth 20, and then squeeze the two distal ends of the plastic springy strip 30 with the fingers to deform the plastic springy strip 30, causing the spring power of the plastic springy strip 30 to force the two opposite bag body sidewalls of the mouth 20 apart from each other.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A water bag comprising a collapsible waterproof bag body adapted for holding water, and a water outlet tube extended from one end of said bag body and mounted with a suction valve for output of water from said bag body, wherein said bag body comprises a mouth in one end thereof remote from said water outlet through which water is filled in said bag body, a plastic springy strip transversely fixedly embedded in a two-layer structure of one of two opposite bag body sidewall of said mouth, two strips of hook materials bilaterally fixedly provided on the outside of said mouth, and two strips of loop material bilaterally fixedly provided on the outside of said bag body and adapted for fastening said strips of hook materials to hold said mouth in a closed rolled up status.

2. The water bag as claimed in claim 1, wherein said plastic springy strip has a planar surface portion disposed at the inner side facing the inside of said bag body, and an elongated rib extended along the length thereof and disposed at an outer side facing the outside of said bag body.
